(19) United States
(12) Patent Application Publication
(10) Pub. No.: US 2025/0104470 A1
(43) Pub. Date: Mar. 27, 2025

(54) VIDEO FACE CLUSTERING

(71) Applicant: Flawless Holdings Limited, London (GB)

(72) Inventors: Pablo GARRIDO, Hawthorne, CA (US); Devesh WALAWALKAR, Los Angeles, CA (US)

(21) Appl. No.: 18/476,101

(22) Filed: Sep. 27, 2023

(51) Int. Cl. G06V 40/16; G06T 7/00; G06T 7/20; G06V 10/762

(52) U.S. Cl. CPC G06V 40/172; G06T 7/0002; G06T 7/20; G06V 10/762; G06T 2207/20132; G06T 2207/30168; G06T 2207/30201

(57) ABSTRACT

A method includes determining, using a motion tracker, a plurality of face tracks from one or more sequences of image frames. Each face track corresponds to a respective instance of a respective face and includes a respective sequence of image frame crops. The method includes fine-tuning, using the determined plurality of face tracks, a pre-trained face identification model to generate, for image frame crops of a common face track, respective embeddings that have a mutually high degree of similarity as measured by a loss function. The method then includes grouping the plurality of face tracks into common identity clusters based at least in part on similarities, as measured by the loss function, between respective embeddings generated using the fine-tuned face identification model for image frame crops within different face tracks.

### BACKGROUND OF THE INVENTION

### Field of the Invention

The present disclosure relates to clustering instances of objects within video data. The disclosure has particular, but not exclusive, relevance to clustering instances of faces having a common facial identity.

### Description of the Related Technology

Video Face Clustering is the task of grouping together human faces in a video among common identities. Video Face Clustering is useful for a range of other tasks including video scene captioning, video question answering, and video understanding, all of which can benefit from an accurate understanding of the spatial location, face size, and identity of the characters that appear in specific scenes. Video Face Clustering may also be used as an editing tool for movie post-production personnel, enabling them to select scenes depicting a specific group of characters, among other benefits. Video Face Clustering may also be used to improve the efficacy, whilst reducing the time and resource costs, of various tasks in the production of digital content, such as VFX, video editing and visual dubbing, including when such tasks are performed with the assistance of artificial intelligence (AI).

Clustering faces in a video is a challenging problem that may be approached using supervised or unsupervised machine learning methods. The movie/television (TV) series domain provides a particular set of challenges for face clustering, due to large variations in facial pose, expression and appearance exhibited by a given character, as well as variations in lighting, size, and other factors that may vary between scenes or within scenes. In view of the unique cinematic style of movies, which may include high resolution, high dynamic range, and/or large variations in facial attributes, face identification (ID) models trained on large-scale datasets tend to perform badly in the movie domain. Furthermore, hand labeling of characters in movies can be tedious, time-consuming, costly and error-prone for a large set of characters, which can limit the usefulness of supervised machine learning methods in the movie domain. The inherent challenges in processing movie data and difficulties in hand labeling often limit movie-specific model training.

### SUMMARY

According to aspects of the present disclosure, there are provided a computer-implemented method, one or more non-transient storage media carrying instructions for carrying out the method, and a system comprising at least one processor and at least one memory storing instructions which, when executed by the at least one processor, cause the at least one processor to carry out the method.

The method includes determining, using a motion tracker, a plurality of face tracks from one or more sequences of image frames. Each face track corresponds to a respective instance of a respective face and includes a respective sequence of image frame crops. The method includes fine-tuning, using the determined plurality of face tracks, a pre-trained face identification model to generate, for image frame crops of a common face track, respective embeddings that have a mutually high degree of similarity as measured by a loss function. The method then includes grouping the plurality of face tracks into common identity clusters based at least in part on similarities, as measured by the loss function, between respective embeddings generated using the fine-tuned face identification model for image frame crops within different face tracks.

The fine-tuning of the face identification model enables the method to leverage pre-training (possibly on very large datasets) even if the face model has not previously been exposed to the facial identities or visual style of the sequences of image frames (which may for example be taken from a TV show or movie). Because a common loss function is used for the fine-tuning and the clustering, the fine-tuned model is optimized for clustering using that loss function.

Further features and advantages of the invention will become apparent from the following description of preferred embodiments of the invention, given by way of example only, which is made with reference to the accompanying drawings.

### BRIEF DESCRIPTION OF THE DRAWINGS

FIG. 1 is a functional block diagram representing functional components of a system for performing a Video Face Clustering method in accordance with examples.

FIG. 2 shows an illustrative example of face tracks being determined from a set of image frames.

FIGS. 3A and 3B schematically show an example of a method of fine-tuning a face ID model.

FIGS. 4A and 4B schematically illustrate a method of coarsely matching face tracks in accordance with examples.

FIGS. 5A and 5B schematically show a method of determining a matching threshold for clustering face tracks in accordance with examples.

FIG. 6 is a flow diagram representing a method of grouping face tracks using a matching threshold in accordance with methods.

FIG. 7 is a flow diagram representing a Video Face Clustering method in accordance with examples.

FIG. 8 is a schematic block diagram representing a system for performing methods described in the present disclosure.

FIG. 9 shows pseudocode for an exemplary Video Face Clustering algorithm.

FIG. 10 shows pseudocode for an exemplary algorithm for clustering face tracks using a fine-tuned face ID model.

### DETAILED DESCRIPTION OF CERTAIN INVENTIVE EMBODIMENTS

Details of systems and methods according to examples will become apparent from the following description with reference to the figures. In this description, for the purposes of explanation, numerous specific details of certain examples are set forth. Reference in the specification to ‘an example’ or similar language means that a feature, structure, or characteristic described in connection with the example is included in at least that one example but not necessarily in other examples. It should be further noted that certain examples are described schematically with certain features omitted and/or necessarily simplified for the ease of explanation and understanding of the concepts underlying the examples.

Embodiments of the present disclosure relate to Video Face Clustering. In particular, embodiments described herein address challenges involved in the application of Video Face Clustering to movie and TV datasets, which may be limited in size and/or may have particular visual styles that prevent the straightforward application of large scale pre-trained models.

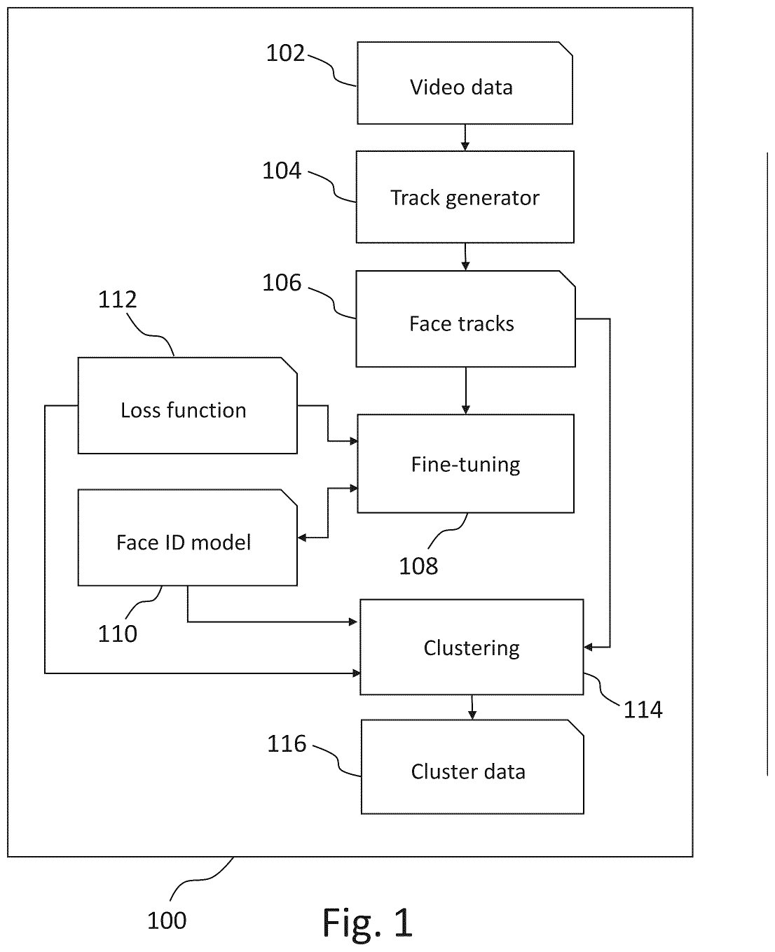

FIG. 1 shows functional components or modules of a system 100 for carrying out Video Face Clustering methods according to the present disclosure. The functional components may be implemented using at least one processor and at least one memory storing instructions to perform the various functions. For example, each functional component may correspond to a respective computer program or a respective part of a computer program. Example hardware and software implementations are described with reference to FIG. 8.

The system 100 stores video data 102, which may be in any suitable video format, such as MP4, MOV, WMV, FLV, AVI, or AVCHD. The video data 102 may have any suitable aspect ratio such as 4:3 (fullscreen), 16:9 (widescreen), or 21:9 (cinematic widescreen), may have any suitable resolution or definition such as 480 p, 720 p, 1080 p, 2 k, 4 k or 8 k, and may have any suitable frame rate such as 24, 30, or 60 frames per second (fps). The video data 102 may include one or more sequences of image frames, for example each corresponding to a respective shot from a movie or TV programme. A shot may be a contiguous portion or section of video data depicting a scene or part of a scene in which there are no significant (e.g. discontinuous) changes in camera angle. Instances of faces (and other objects) within a given shot are expected to move and vary in a continuous manner, enabling continuous motion tracking of faces within a given shot, whereas discontinuous changes in location, orientation, motion, and/or appearance may take place between shots. In other examples, a sequence of image frames may correspond to an entire movie or an entire episode of a TV programme. In some examples, the video data 102 may be received or otherwise obtained in the form of one or more entire movies or TV episodes, or portions thereof, and a cut detection algorithm may be applied to split the video data 102 into separate shots. A change of shot may occur when there is a significant change of camera angle and/or a change of scene. Examples of cut detection algorithms are threshold-based cut detection algorithms, for example as provided via the PySceneDetect API available at https://www.scenedetect.com/api/.

The video data 102 is processed using a track generator 104 to determine a set of face tracks 106. Each face track 106 may correspond to a single instance of a face appearing within the video data 102, and may include crops from a contiguous sequence of image frames. In examples where cut detection has been performed, each face track 106 may correspond to an instance of a given face within a given shot. A given shot may contain multiple face tracks, for example corresponding to different facial identities or a given face moving out of shot and then back into shot.

The track generator 104 may use various computer vision (CV) techniques such as neural network-based CV techniques to generate the face tracks. The track generator 104 may for include an object detector and a motion tracker. The object detector may implement any object detection algorithm suitable for detecting faces, such as neural network-based algorithms including Region-Based Convolutional Neural Networks (R-CNNs), Single Shot Detector (SSD), Vision Transformer (ViT) or YOLOv7. An example of an object detection algorithm specifically trained for detecting faces is RetinaFace, described in the article RetinaFace: Singleshot multi-level face localisation in the wild in Conference on Computer Vision and Pattern Recognition (CVPR), pp. 5203-5212. IEEE, 2020, the entirety of which is incorporated herein by reference for all purposes. The object detector may determine or estimate framewise dimensions and locations of bounding boxes containing faces within image frames. The motion tracker may implement any suitable motion tracking algorithm, for example Simple Online and Realtime Tracking (SORT), FairMOT, TransMOT, ByteTrack, Tracking Everything Everywhere All at Once, or BoT-SORT, as described in the article BoT-SORT: Robust associations multi-pedestrian tracking, arXiv:2206.14651, 2022, the entirety of which is incorporated herein by reference for all purposes. The motion tracker may associate a unique identifier with face crops corresponding to a single instance of a given face in a given shot, thereby determining a face track. Although the track generator 104 may include a separate object detector and motion tracker, in other examples the track generator 104 may be implemented using a single algorithm, for example a video object detection object such as VSTAM, Temporal ROI Align, or SLTnet FPN-X101. Determining the set of face tracks 106 may include extracting image frame crops as separate image files, and/or may include storing metadata indicative of the image frame crops, for example indicating framewise dimensions and locations of bounding boxes containing the faces. Determining the set of face tracks 106 may optionally include identifying a representative crop for each face track 106 from which the facial identity is expected to be clearly recognisable by a human user (and can therefore be presented in a user interface to enable a user to easily identify which facial identity a given track represents. The representative crop may be identified for example based on area of the crop (e.g., a largest crop within the track), the pose of the face (e.g., a crop with a substantially front-facing face), and/or the image quality (e.g. a crop which exhibits low levels of blurring and/or has good lighting levels). In some options, the representative crop may be identified using CV techniques, such as neural network-based CV techniques.

The face tracks 106 determined by the track generator 104 may include large numbers of image frame crops in which neighboring crops only exhibit minor variations. In their unprocessed state, the face tracks 106 may therefore constitute excessively large and inefficient datasets for training a machine learning model. To mitigate this, a subset of crops may optionally be selected or sampled to generate final face tracks for subsequent processing. The selecting or sampling may be random, rules-based, or data-driven. For example, a face crop may be sampled at fixed intervals such as every nth frame, where n is selected such that there are expected to be significant changes in either facial pose and/or expression through the track duration. The size of the interval may depend on the frame rate of the video data 102. For 24 fps, an interval of n=12 may be used, so that the resulting track includes two crops per second. The choice of interval may further depend on other factors such as the semantic content of the video data 102 and/or available resources for subsequent processing. In other examples, the full set of image frame crops may be processed using suitable CV techniques to select a subset of crops that exhibit a broad range of poses, expressions, and/or other aspects of appearance within a given track.

In addition to the selecting or sampling of crops from the face tracks 102 as described above, crops that are unsuitable for subsequent processing may be filtered out, for example before and/or after motion tracking. Face crops filtered out in this way may be assigned a “unidentified” facial identity and may be omitted from subsequent model training and clustering. Face crops may be filtered based on a quality evaluation. The quality evaluation may for example include disregarding crops having areas below a certain area threshold, and/or keeping a fixed number or proportion of crops having the largest areas (e.g., in a given track or globally), and/or disregarding crops having a blurring level higher than a blurring threshold, and/or keeping a fixed number or proportion of crops having the least blurring (e.g., in a given track or globally), and/or disregarding crops having an occlusion level higher than an occlusion threshold, and/or keeping a fixed number or proportion of crops having the least occlusion (e.g., in a given track or globally). Filtering out low quality crops may result in the face tracks corresponding to prominent faces appearing in the foreground of the video data 102, whilst improving the quality of the dataset for subsequent model training and clustering purposes.

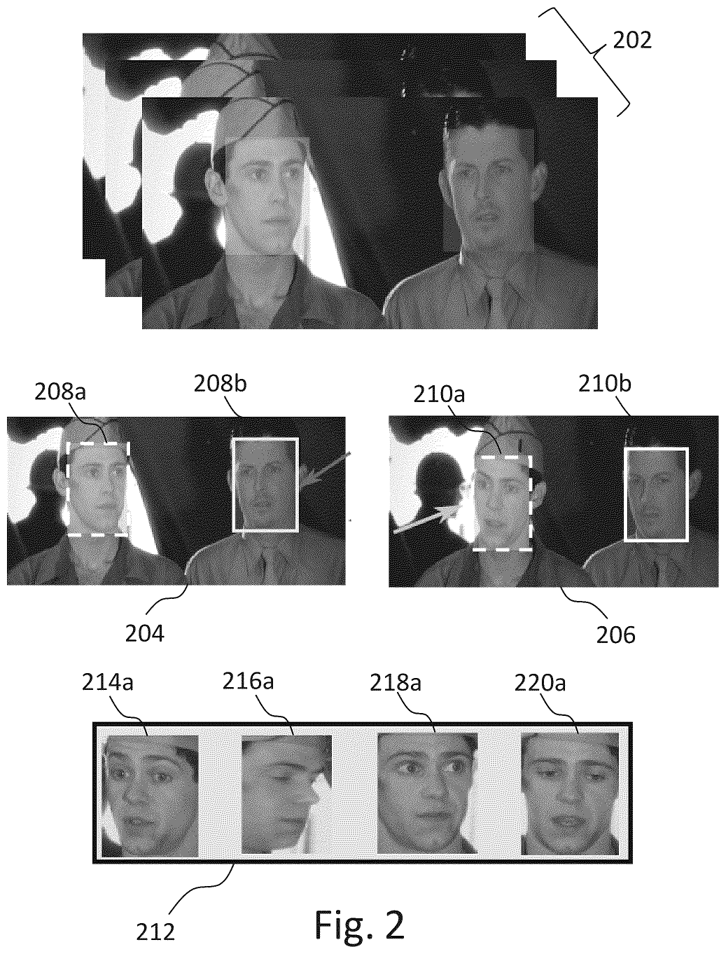

FIG. 2 shows an example of a sequence of image frames 202 corresponding to a shot from a feature film. Although the sequence is depicted as having three image frames for clarity, a sequence of image frames from a shot may have many more image frames, such as hundreds, thousands, or tens of thousands of image frames. The sequence of image frames 202 includes a first image frame 204 and a second image frame 206, which are not necessarily the first two image frames of the shot and may be separated by several intervening image frames. In this example, image frame crops 208a, 208b have been determined in the first image frame 204, and image frame crops 210a, 210b have determined in the second image frame 204. Using a motion tracker, the image frame crops 208a and 210a are identified as belonging to a first face track 212, and the image frame crops 208b and 210b are identified as belonging to a second face track (not shown). The first face track 212 includes a sequence of image frame crops also including image frame crops 214a, 216a, 218a, 220a. In this example, the first face track 212 has undergone sampling such that the temporal separation of the image frame crops results in significant changes of pose and/or expression between neighboring crops.

The task of Video Face Clustering is to group the face tracks 106 according to facial identity. Additionally, the face crops within the determined face tracks 106 also play the role of positive training examples in that it can be assumed with a high level of confidence that pairs of crops within a given face track have a common facial identity. Advantageously, the methods described herein may not require negative training examples, such as pairs of face crops that can be assumed to have a different facial identity. Obtaining negative training examples in this context can be an error-prone, complex and time-consuming task, for example relying on co-occurring tracks, temporal constraints, or using complex modules that depend on finetuned parameters to mine negative pairs.

Returning to FIG. 1, the determined face tracks 106 are used for fine-tuning 108 of a pretrained face ID model 110. The purpose of the fine-tuning 108 is to train the face ID model 110 further to be better fitted to the dataset defined by the face tracks 106, prior to the face ID 110 model being used for clustering as described hereinafter.

The face ID model 110 may be any suitable type of machine learning model, such as a neural network model, trained to classify images according to facial identity. The face ID model 110 may have been pre-trained on a large and diverse dataset of video data and/or image data, which may or may not include images/video from the same domain as the video data 102. The face ID model 110 may for example include a convolutional neural network (CNN) or a ViT. In one example, the face ID model 110 may include the ArcFace-R101 face recognition model described in the article ArcFace: Additive angular margin loss for deep face recognition, in Conference on Computer Vision and Pattern Recognition (CVPR), pp. 4690-4699, IEEE, 2019, the entirety of which is incorporated herein by reference for all purposes. Advantageously, the methods described herein may be agnostic to the nature of the face ID model 100, and may be applied to any trainable (e.g., differentiable) face ID or face recognition model arranged to process images to generate embeddings or representative of faces appearing within the images. An embedding may be a vector, array, or other data structure representative of features of an image. The embedding may have a lower dimensionality than the image (e.g., the number of pixel values), which may force. The embedding vector may for example have tens, hundreds, or thousands of dimensions, whereas the image may have tens of thousands, hundreds of thousands, or millions of dimensions. The face ID model may be arranged to output a single embedding for a given image, or may output multiple embeddings for a given image. In an example where the face ID model includes a ViT, the model may be arranged to output a class token embedding and a patch token embedding.

The fine-tuning 108 of the face ID model 110 uses a loss function 112, which may be a similarity loss for evaluating a similarity of embeddings between images. In some examples, the similarity loss may compare pairs of embeddings generated by the face ID model 110, for example using a distance metric such as a Euclidean distance or a cosine distance. However, in other particularly advantageous examples, a self-supervised learning (SSL) loss may be used, which may be directly optimized to evaluate the similarity of embeddings within the vector space of embeddings generated by the specific face ID model 110. Unlike generic distance functions, such a loss function may forego making any implicit assumptions about the learned vector space.

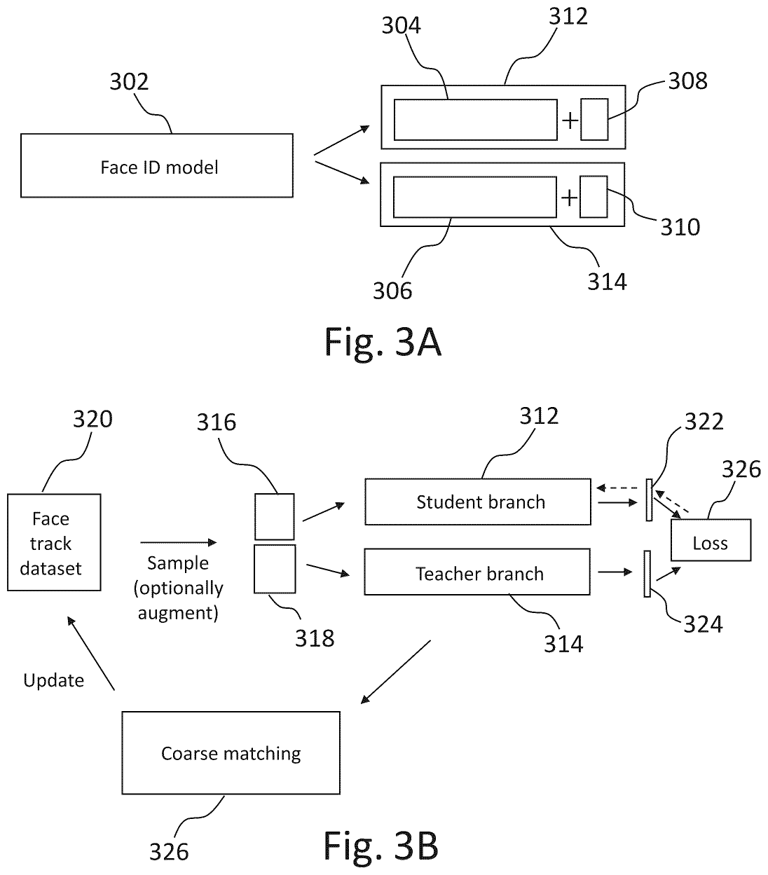

The loss function 112 may be used in combination with a self-supervised learning method as described below with reference to FIGS. 3A and 3B. Traditional supervised fine-tuning methods would require human supervision to label tracks with ground truth facial identities, which would be tedious and costly for large numbers of face tracks, whilst simultaneously defeating the object of automated Video Face Clustering because such labelling may have to be performed for each dataset to which the task is applied. The present disclosure instead proposes a self-supervised learning method in which no human supervision may be dispensed with entirely, enabling full automation of the Video Face Clustering pipeline. As discussed above, a particular advantage of the disclosed method is the lack of reliance on negative training examples.

Turning to FIG. 3A, a pre-trained face ID model 302 is duplicated to generated two copies 304, 306. Respective multilayer perceptrons (MLPs) are attached to the copies 304, 306 as model heads 308, 310. The model heads 308, 310 may have identical architectures to one another and may be formed of several layers such as fully-connected layers (for example, 3, 5 or 10 layers) each having a suitable activation function, for example a Gaussian Error Linear Unit (GELU), rectified linear unit (ReLU), or an exponential linear unit (ELU). The model heads 308, 310 may have the same output dimensionality as the face ID model 302 or may have a different output dimensionality to the face ID model 302. The model heads 308, 310 may be initialized in any suitable manner, for example randomly. In the context of the present training method, the combination of the first copy 304 and its model head 308 may be referred to as a student branch 312, and the combination of the second copy 306 and its model head 310 may be referred to as a teacher branch 314. In examples where the face ID model 302 is based on a ViT, each branch may include two parallel model heads corresponding to patch embeddings and class embeddings.

Having prepared the student branch and the teacher branch, the fine-tuning 108 proceeds with curating pairs of face crops from each face track's sampled crop set. A pair of face crops may be sampled from a given face track and, optionally, one or more augmentations may be applied to either or both sampled crops. The augmentations may include, for example, random applications of resizing, horizontal flipping, and/or color temperature variation. In some examples, multiple versions of each crop may be determined, leading to multiple combinations that can be used as pairs for the fine-tuning process. As shown in FIG. 3B, the sampling and optional augmentation results in a first face crop 316 and a second face crop 318 being obtained from a face track database 320. The first face crop 316 is passed through the student branch 312 to generate a first embedding 322, and the second face crop 318 is passed through the teacher branch 314 to generate a second embedding 324. The first embedding 322 and the second embedding 324 are then compared using the loss function to determine a loss 326. The loss function may be an SSL loss given by the following equation:

$${L}_{ssl} = - 1 * soft {max ( \frac{{embed}_{t}}{{temp}_{t}} )}^{T} log ( soft max ( \frac{{embed}_{s}}{{temp}_{s}} ) ) ,$$

where embedₜ is the embedding generated by the teacher branch, embedₛ is the embedding generated by the student branch, and fixed softening temperatures tempₜ and/or tempₛ are optionally included as hyperparameters. Other variants of the SSL loss are possible, for example:

$${L}_{ssl} = - 1 * soft {max ( \frac{{embed}_{t} - c}{temp} )}^{T} log ( soft max ( {embed}_{s} ) ) ,$$

where in this example only a single softening temperature is included, and the teacher embedding is replaced with a deviation of the teacher embedding from a rolling average or moving average c of teacher embeddings computed across training batches. It will be appreciated that other variants of these loss functions are possible as well.

In an example where the student branch 312 and the teacher branch 314 are based in ViTs, separate SSL losses may be determined for the patch token embeddings and the class token embeddings. The SSL loss functions above are asymmetric with respect to the first crop 316 and the second crop 318. In some examples, the loss 326 may additionally include a complementary SSL loss term with the same form but evaluated with the first crop 316 passed through the teacher branch 314 and the second crop passed through the student branch 312.

The SSL loss (or losses) are backpropagated only through the student branch 312 (as indicated by dashed arrows in FIG. 3B) to determine the gradient of the loss (or losses) with respect to the parameters of the student branch 312. Trainable parameter values (e.g., weights) of the student branch 312 are updated using a gradient-based optimizer, such as stochastic gradient descent (SDG), Adam, RMSProp, or AdamW. Techniques such as batch normalization may be used to improve the efficiency of the training process. Trainable parameter values of the teacher branch 314 may be updated to a moving average of the student branch parameter values at regular training intervals. This process may be repeated iteratively over many iterations covering one or more passes through the face track dataset 320 (epochs). As a result of this training process, both the student branch 312 and the teacher branch 314 can learn to generate similar embeddings for a given facial identity, without the need for negative training examples.

Given that the model heads 308, 310 may be randomly initialized, in some examples the copies 304, 306 of the base face ID model 302 may be frozen for an initial training phase, while the model heads 308, 310 are updated using the method described above. This initial phase may continue for a fixed number of iterations or epochs, or when another stopping condition is satisfied. Following this, both the base model copies 304, 306 and the model heads 308, 310 are updated together. Such a structured training regime may encourage the model branch heads 308, 310 to produce consistent embeddings for a given facial identity, thus improving overall clustering across various poses, expressions, lighting, and appearance changes observed in a video. In a particular example, the initial training phase is carried out over 10 epochs, following which one or more further training stages are carried out for training the entire branches 312, 314, with each further training stage covering 10 epochs. In this example, the AdamW optimizer is used with an initial learning rate of 10⁻⁴ and a cosine decay scheduling and reduce the learning to a final value of 10⁻⁵. The initial learning rate may be linearly warmed up for the first 5 epochs for each stage from a starting value of 5×10⁻⁶.

As a result of the fine-tuning process described above, both the student branch 312 and the teacher branch 314 can learn to generate consistent embeddings for a given facial identity, without the need for negative training examples. However, since a given face track is taken from within a single shot, there is likely to be little significant variation in lighting, and/or face appearance across the track, which may limit the model learning capacity. For a movie or TV episode/series, such parameters can vary significantly. To account for such variations and to facilitate further model learning, in some examples a coarse matching or soft matching process may be applied to identify face tracks that correspond to a common facial identity with a high level of confidence. Pairs of face crops sampled between such soft-matched face tracks may be used for further fine-tuning, for example using the same training method as described above, which may enable the model to adapt to a range of lighting and appearance variations encountered for a given face across the entire dataset. In the example of FIG. 3B, coarse track matching 326 is performed after a full training loop has been carried out. This may result in the face track dataset 320 being updated such that certain face tracks are assigned to a common facial identity. A subsequent training loop may then be carried out in which pairs of face crops are sampled between matched face tracks. Further pairs may optionally be sampled from within given face tracks, for example for face tracks that are not matched to any other face tracks. Further training loops may be carried out, with each loop potentially having newly matched face tracks. This process may be carried out for a fixed number of loops or until another stopping condition is satisfied, such as no further face tracks being matched at the end of a given loop.

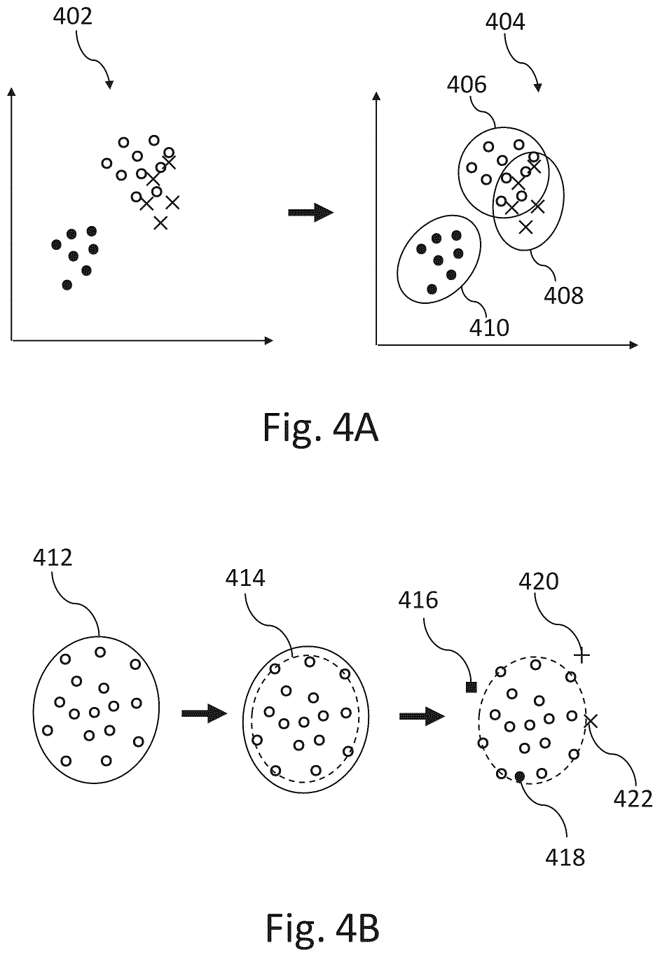

FIGS. 4A and 4B illustrate an example of a method of matching face tracks to facilitate further model fine-tuning as described above. In plot 402 of FIG. 4A, points shown as filled circles, empty circles, and crosses correspond to a two-dimensional representation of embeddings generated by a fine-tuned face ID model and corresponding to three respective face tracks (for example a t-distributed stochastic neighbor embedding (t-SNE) representation). It is observed that there is significant overlap between the embeddings shown as empty circles and the embeddings shown as crosses, possibly suggesting that these embeddings correspond to face tracks having a common facial identity. To quantify this similarity, probability density functions (pdfs) may be estimated for the embeddings associated with respective face tracks, which may then be leveraged for matching. For example, a multivariate Gaussian distribution or another distribution (e.g., multivariate t-distribution, multivariate stable distribution) may be fitted to some or all of the points in the embedding space corresponding to a given face track. Plot 404 of FIG. 4A shows three ellipses 406, 408, 410 representing approximate regions covered by multivariate Gaussian distributions fitted to the three sets of embeddings from plot 402 (e.g. a fixed Mahalanobis distance from the mean of each distribution).

Having determined the pdfs corresponding to the various face tracks, the pdfs may be evaluated at the corresponding embeddings to determine probability density thresholds for use in matching the face tracks. For example, the pdf for a given face track may be evaluated for all of the embeddings corresponding to that face track, and a given proportion of the embeddings may be identified as outlier embeddings based on their probability densities. For example, the lowest 10%, 20%, 25% or 30% may be identified as outlier embeddings, where a lower proportion corresponds to a stricter condition for soft matching. The mean probability density for the outlier embeddings may then be determined as the probability density threshold for that face track. To determine whether a first face track is a soft match with a second face track, a mean embedding is determined for the second face track, and the probability density of mean embedding is determined under the distribution for the first face track. If the probability density for the mean embedding is higher than the probability density threshold for the first face track, then this indicates that face crops within the second face track are more consistent with face crops in the first face track than the outliers of the first face track. The inventors have found this to be a reliable criterion for determining that the first face track and the second face track correspond to a common facial identity. In this case, the first face track may be soft-matched with the second face track, meaning that the two face tracks are determined to correspond to a common facial identity with a high degree of confidence.

FIG. 4B shows a solid ellipse 412 representing a Multivariate Gaussian distribution for a set of embeddings corresponding to a given face track (shown as empty circles), and a dashed ellipse 414 representing a region of the embedding space corresponding to the probability density threshold. The points 416, 418, 420, 422 represent mean embeddings for four face tracks that are candidate soft matches with the given face track. It is observed that the face track 418 lies inside the dashed ellipse 414, indicating that its probability density is higher than the probability density threshold for the given face track, meaning that the two face tracks can be soft matched.

For each face track, the soft matching test described above may be performed for all other face tracks within the face track dataset (with the possible exceptions of face tracks filtered out due to low quality scores, as described below). In this way, the test will be applied bidirectionally for all pairs of face tracks. The criterion for soft matching may require the soft matching condition to be satisfied in both directions (i.e., for a given pair, each face track's mean embedding has a higher probability density than the other face track's probability density threshold), or it may be sufficient for the condition to be satisfied in only one direction (i.e., for a given pair, at least one face track's mean embedding has a higher probability density than the other face track's probability density threshold). It will be appreciated that other soft matching conditions are possible, for example by determining a mean probability density under a first face track's distribution for all embeddings associated with a second face track, and determining whether this mean probability density exceeds a probability density threshold. In other examples, the probability density threshold may be a fixed probability density, or the matching condition may be based on other criteria such as a threshold Mahalanobis distance. In other examples still, soft matching of face tracks may be performed without recourse to pdfs, for example based on threshold values of a distance metric such as Euclidean distance or cosine distance.

Returning to FIG. 1, the fine-tuned face ID model 110 is used for final clustering 114 of the face tracks 106, to generate cluster data 116 indicating which face tracks share common facial identities. The cluster data 116 may for example assign a unique identifier to face tracks corresponding to a given facial identity. The clustering 114 may be based on similarities between embeddings as measured using the same loss function 112 as used for the fine-tuning 108. For example, the clustering may be based on the SSL loss described above, which has the significant benefit of being directly optimized to evaluate embedding similarity for the learned vector space of the face ID model 110. In such cases, it may not be necessary to make any implicit assumptions made about the learned space through generic distance functions.

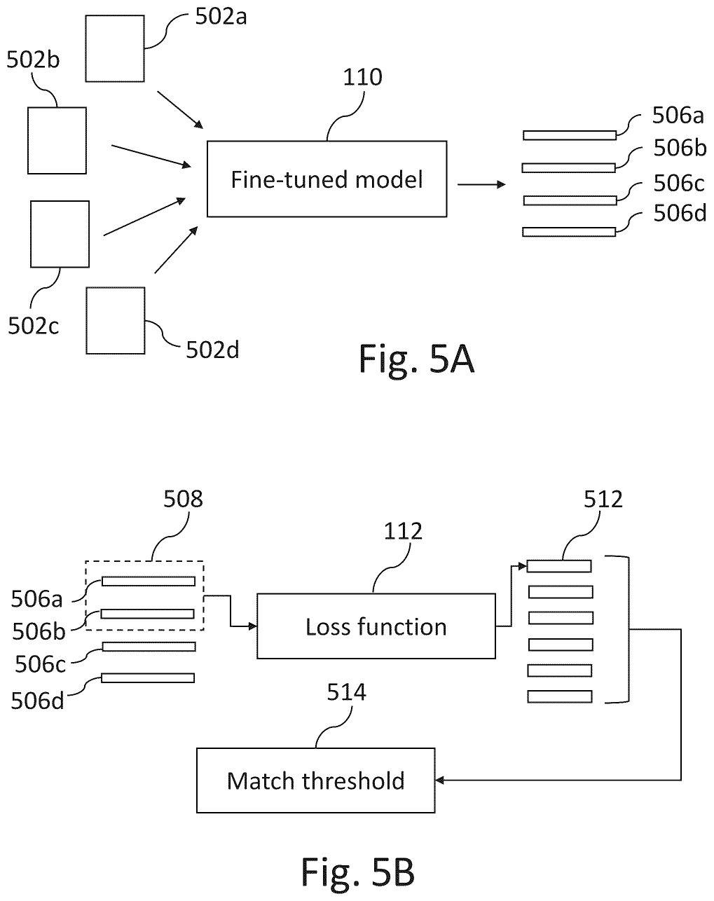

Instead of using a global threshold for matching face tracks, in some examples clustering 114 may determine a custom matching threshold for each face track, which can account for how well the face ID model 110 has learned about that particular facial identity. FIGS. 5A and 5B show an example of a method by which a custom matching threshold may be determined. As shown in FIG. 5A, face crops 502a, 502b, 502c, 502d from a common face track are passed through the fine-tuned face ID model 110 to generate corresponding embeddings 506a, 506b, 506c, 506d. A given pair 508 of the generated embeddings is passed through loss function 112 (optionally symmetrised between the first embedding 506a and the second embedding 506b as described above) to generate a similarity value 512. This process is carried out for some, or preferably all, pairs of embeddings 506 corresponding to the (optionally filtered and/or sampled) face track. The resulting losses may then be used to determine a matching threshold 514. In one example, the matching threshold 514 may be determined as the average of the determined similarity values. The resulting matching threshold 514 represents quantitatively how well the model matches face crops belonging to a given common facial identity since the crops are part of the same track.

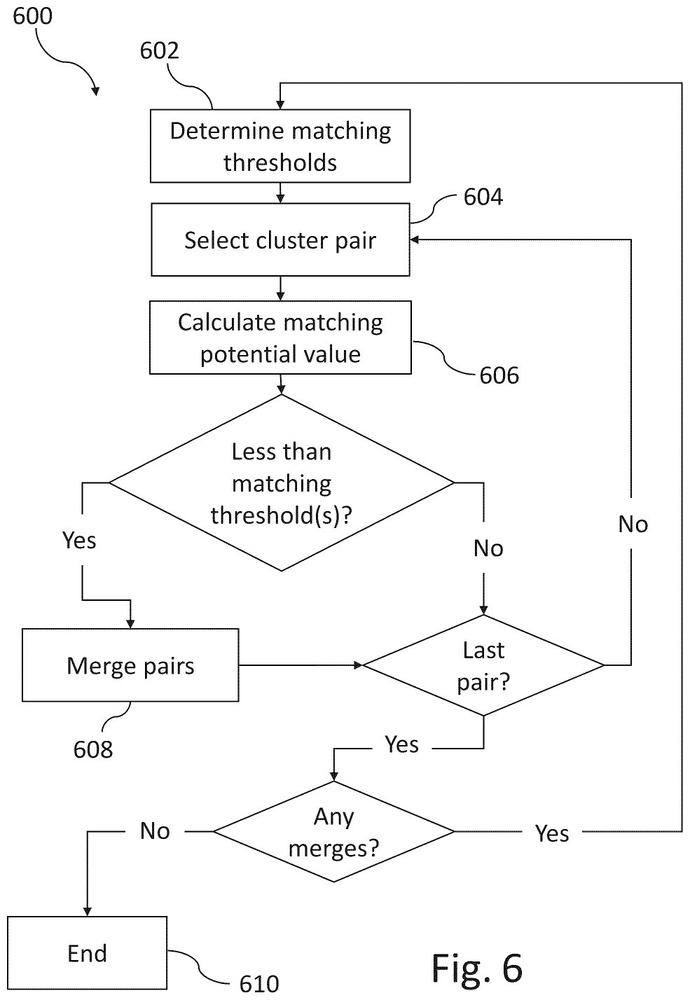

FIG. 6 shows an example of an iterative merging method 600 for clustering face tracks using custom match thresholds. Prior to the method 600 taking place, a unique cluster identifier may be assigned to each face track (with the possible exceptions of face tracks filtered out due to low quality scores, as described below). In this way, the face tracks are initially associated with respective different clusters. The method 600 proceeds with determining, at 602, a custom matching threshold for each cluster, for example using the method described above with reference to FIG. 5. A pair of clusters is then selected 604, and a matching potential value is determined for the selected pair of clusters at 606. The matching potential value may be determined based on similarity scores for pairs of crops between the two clusters, as determined using the fine-tuned face ID model and the loss function/similarity metric used to train the face ID model. In particular, the matching potential value may be a mean similarity score for all pairs of crops between the two clusters.

The pair of clusters may be merged, at 606, in dependence on a comparison between the matching potential value and the matching threshold of one or both clusters. For example, the clusters may be merged in the event that the matching potential value is less than either one of the cluster's matching threshold. Alternatively, the clusters may be merged only in the event that the matching potential value is less than both clusters' matching threshold.

The steps 604-608 may continue iteratively until all pairs of clusters have been tested for matching. All positively matched pairs are searched for common tracks so that the can be combined together into a bigger cluster. For example, if track pairs 1,2 and 2,3 are matched, then tracks 1, 2, and 3 are combined together to a common cluster.

If any pairs of clusters were merged during the loop over cluster pairs, then the method 600 may return to 602, where updated matching thresholds may be determined for the newly merged clusters. The steps 604-608 may then be carried out again for all pairs involving the newly merged clusters. For later iterations, where clusters could have more than one face track, mean track embeddings may be considered instead of a combined set of face crops for cluster pair matching, to avoid exponentially growing match computations.

The method 600 may continue iteratively until no new merges take place within a loop over cluster pairs, at which point the clustering process may end at 610. At this point, face tracks corresponding to a common facial identity are expected to belong to a common cluster (for example being assigned a common cluster identifier).

In some examples, bad quality crops/tracks may be excluded from the coarse track matching and/or final clustering processes described above. Bad quality of a given face track often relates to model uncertainty, which can result in false track matches during the coarse matching phase or wrong clustering in the final clustering stage. To estimate the quality of face crops, the consistency of embeddings predicted by different subnetworks of a face ID model (e.g., the fine-tuned face ID model 110) for multiple instances of the same face crop may be determined, the subnetworks being defined by different dropout patterns (e.g. randomly applied dropout patterns). For bad quality crops, the face ID model is expected to predict embeddings with high variance, thus resulting in a low-quality score. The quality score for a given crop may therefore depend on differences between such embeddings, for example as measured using any suitable distance metric such as a Euclidean distance. The quality score for a given face crop may for example be given by

$$q = 2 σ ( - \frac{2}{{m}^{2}} {\sum }_{i < j} d ( {x}_{i} , {x}_{j} ) ) ,$$

where {xᵢ}₁^{m} is a set of embeddings determined using the different subnetworks and d is a distance metric (e.g., Euclidean distance). The sigma function ensures the quality value is between 0 and 1. Further details on methods of determining quality scores can be found in the article SER-FIQ: unsupervised estimation of face image quality based on stochastic embedding robustness in Conference on Computer Vision and Pattern Recognition (CVPR), pp. 5650-5659. IEEE, 2020, the entirety of which is incorporated herein by reference for all purposes. To determine a track quality score (tqs) for a given track, quality scores may be averaged over all face crops within a given face track. A threshold for excluding face tracks may be determined, for example based on a median absolute deviation (MAD) of the tqs values for the entire set of face tracks. For a set of N face tracks, the threshold may for example be given by thresh(tqs(N))=t̅q̅s̅(̅N̅)̅−2.7×MAD(tqs(N)), where tqs(N)={tqs(t₁), tqs(t₂), . . . , tqs(tⱼ)}∀j={1,2, . . . , N}. The inventors have empirically found the value 2.7 to be close to optimal for removing bad quality tracks from a wide range of movie track sets, though it will be appreciated that other values may be suited to other types of dataset. Tracks having a tqs lower than thresh(tqs(N)) may be excluded from either or both of the coarse track matching and final clustering processes, and their final track cluster identifiers may be set to Unknown. The quality-based filtering of face tracks may be carried out during each training loop (e.g., before or after coarse track matching) as additional face tracks may be filtered out as the face ID model becomes further fine-tuned on the dataset.

Advantageously, the Video Face Clustering process described above may not rely on any user-defined parameters being provided as inputs. In particular, the iterative merging approach does not require the number of clusters to be provided as input. Furthermore, all thresholds used in the soft matching and clustering processes can be data-driven rather than user-defined. As a result, the method is capable of being fully automated without human supervision, and is not susceptible to human errors or biases.

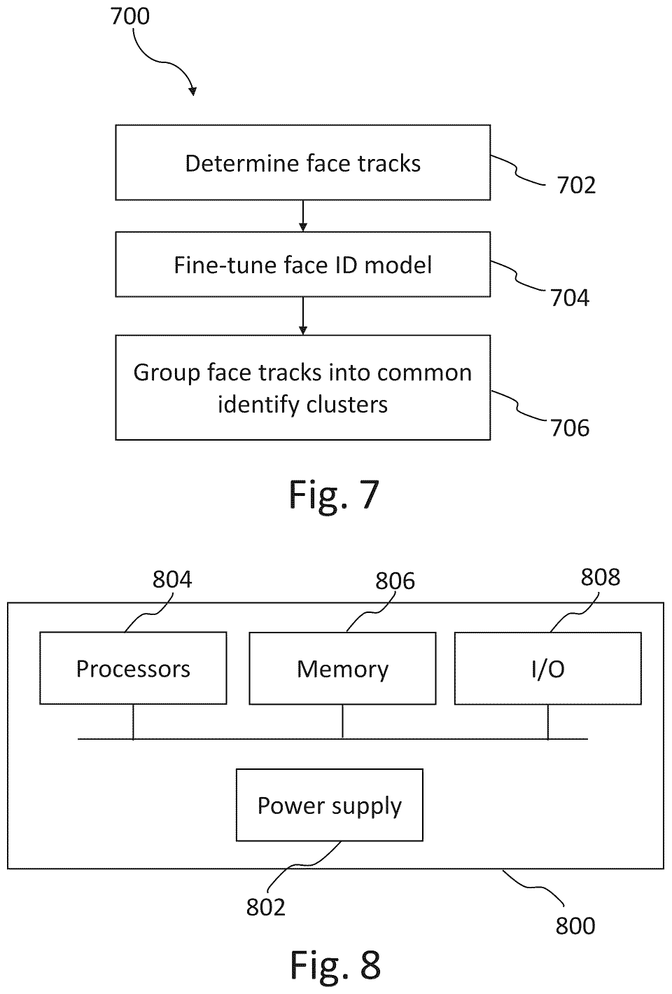

The Video Face Clustering process described herein is summarised by FIG. 7. The method 700 begins with determining, at 702, a set of face tracks from one or more sequences of image frames, each face track corresponding to a respective instance of a respective face and comprising a respective sequence of face crops. The set of face tracks may be determined using a motion tracker in combination with an object detector trained to detect faces. The method 700 continues with fine-tuning, using the determined set of face tracks, a pre-trained face ID model to generate, for image frame crops of a common face track, respective embeddings that have a mutually high degree of similarity as measured by a loss function. The loss function may be an SSL loss and the fine-tuning may use teacher and student branches to enable model learning without the need for negative training examples. The method 702 may end with grouping, at 706, the set of face tracks into common identity clusters based at least in part on similarities, as measured by the loss function, between respective embeddings generated using the fine-tuned face ID model for image frame crops within different face tracks. The grouping may use an iterative merging approach.

The methods described herein may be performed using any suitable computing apparatus. For example, computing system 800 includes a power supply 802, one or more processors 804, memory 806, and input and output devices 808. The computing system 800 may be a single device or may include multiple devices connected over a network. The power supply 802 may include a mains supply and/or a battery. The processors 804 may include, for example, one or more of each of a central processing unit (CPU), a graphics processing unit (GPU), and/or a neural processing unit (NPU). Any of these processors may have multiple cores, and various parts of the Video Face Clustering pipeline described herein may be parallelized between cores and/or between processors. For example, determining, filtering, and sampling face tracks prior to model fine-tuning may be parallelized between batches, with each batch corresponding to a portion of video data. Model fine-tuning may be parallelized across GPU cores. The memory 806 (which in the present disclosure may refer to working memory and/or storage) may store program code for implementing any of the functional components or modules described herein. The program code may be written in any suitable programming language and may make use of any software development framework such as PyTorch and/or Tensorflow. Certain subroutines may further make use of lower layer task-specific and/or hardware-specific frameworks, such as CUDA by Nvidia (RTM) or Triton by OpenAI (RTM) for model training. The input and output devices 808 may enable a user to interact with a user interface for inspecting or modifying the cluster data generated by the Video Face Clustering pipeline. For example, the user interface may present a representative thumbnail for each face track within a given cluster, and may enable a user to manually move a thumbnail from one cluster to another if the user determines that the corresponding track has been assigned to an incorrect cluster. The user may also be able to delete a track thumbnail, which may have the effect of moving the corresponding track to the Unknown cluster. The user may also be able to review tracks in the Unknown cluster (for example, those that were filtered out based on tqs) and optionally move them to existing clusters or new clusters. The user may also be permitted to manually split a given cluster into multiple variants.

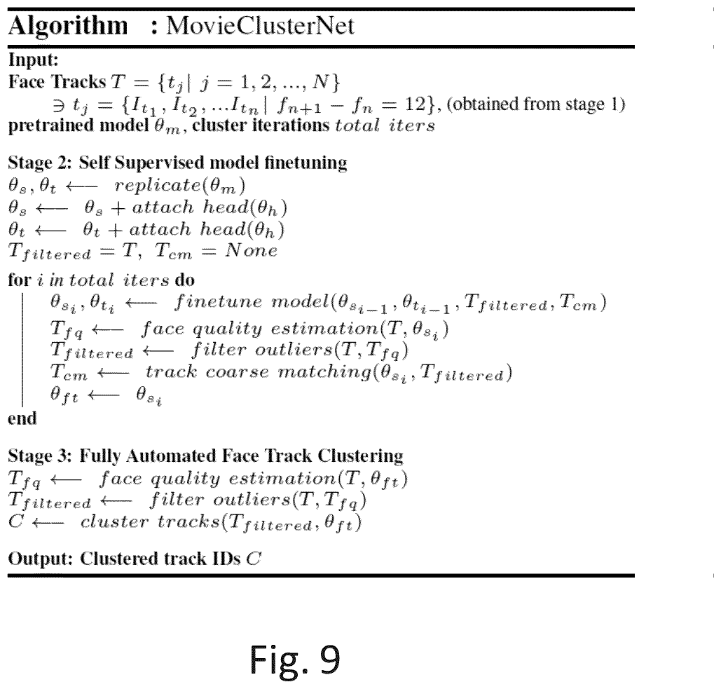

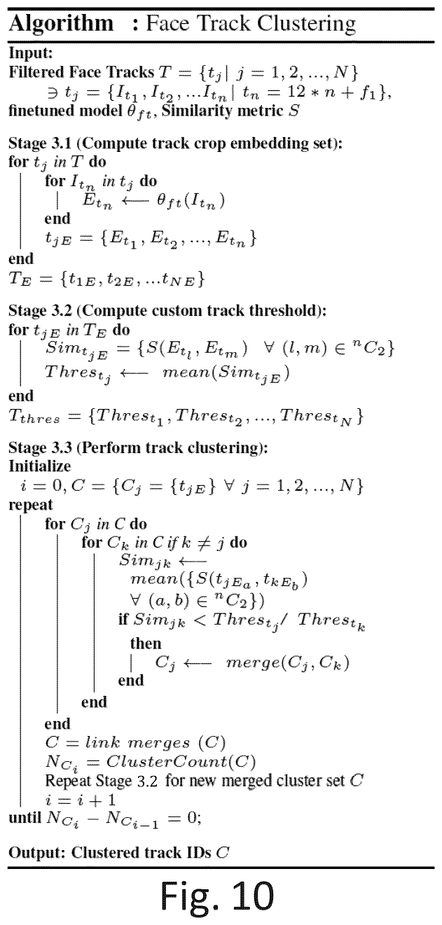

FIG. 9 shows an example of an algorithm for implementing a Video Face Clustering pipeline in accordance with the present disclosure. The input to the algorithm includes a set T of face tracks tⱼ filtered to include every 12th image crop, along with a fine-tuned face ID model θ_{ft} and a chosen number of iterations total iters. Stage 2 of the algorithm performs self-supervised model fine-tuning, including filtering based on face quality estimation and coarse face track matching. Stage 3 of the algorithm performs fully automated face track clustering using the fine-tuned face ID model θ_{ft} (as described in more detail with reference to FIG. 10).

FIG. 10 shows an example of an algorithm for implementing face track clustering based on iterative merging as described herein. The input to the algorithm includes a set T of face tracks tⱼ filtered to include every 12th image crop, along with a fine-tuned face ID model θ_{ft} and a similarity metric S corresponding to the loss function used to fine-tune the face ID model θ_{ft}. Stage 3.1 of the algorithm uses the fine-tuned face ID model θ_{ft} to determine embeddings Eₜⱼ for the face crops within the filtered face track. Stage 3.2 determines a custom matching threshold for each face track. Stage 3.3 performs iterative merging using the custom matching thresholds to determine a set of clustered track IDs C as an output.

At least some aspects of the examples described herein with reference to FIGS. 1-10 comprise computer processes or methods performed in one or more processing systems and/or processors. However, in some examples, the disclosure also extends to computer programs, particularly computer programs on or in an apparatus, adapted for putting the disclosure into practice. The program may be in the form of non-transitory source code, object code, a code intermediate source and object code such as in partially compiled form, or in any other non-transitory form suitable for use in the implementation of processes according to the disclosure. The apparatus may be any entity or device capable of carrying the program. For example, the apparatus may comprise a storage medium, such as a solid-state drive (SSD) or other semiconductor-based RAM; a ROM, for example, a CD ROM or a semiconductor ROM; a magnetic recording medium, for example a hard disk; optical memory devices in general; etc.

The above embodiments are to be understood as illustrative examples of the invention. Further embodiments of the invention are envisaged. For example, the methods described herein may be applied to datasets across multiple movies and/or TV series. Some or all of the disclosed techniques may equally be applied to objects other than human faces. Further improvements or modifications to the methods may also be possible. For example, if a generic face ID model has learned an incorrect similarity between two distinct facial identities, then the methods described herein may adapt to this error and provide a false positive cluster for that given pair. This may be addressed by automatic detection of such biases, so that the given pair's embeddings could be specifically pulled apart to eliminate the bias. This could be achieved by incorporating a cluster outlier detection technique based on similarity values for a cluster's set of tracks.

It is to be understood that any feature described in relation to any one embodiment may be used alone, or in combination with other features described, and may also be used in combination with one or more features of any other of the embodiments, or any combination of any other of the embodiments. Furthermore, equivalents and modifications not described above may also be employed without departing from the scope of the invention, which is defined in the accompanying claims.

What is claimed is:

1. A system comprising:
at least one processor; and
at least one memory storing machine-readable instructions which, when executed by the at least one processor, cause the at least one processor to carry out operations comprising:
determining, using a motion tracker, a plurality of face tracks from one or more sequences of image frames, each face track corresponding to a respective instance of a respective face and comprising a respective sequence of image frame crops;
fine-tuning, using the determined plurality of face tracks, a pre-trained face identification model to generate, for image frame crops of a common face track, respective embeddings that have a mutually high degree of similarity as measured by a loss function;
grouping the plurality of face tracks into common identity clusters based at least in part on similarities, as measured by the loss function, between respective embeddings generated using the fine-tuned face identification model for image frame crops within different face tracks.

2. The system of claim 1, wherein the fine-tuning comprises:
matching a first face track to a second face track based at least in part on a similarity of respective embeddings generated by the face identification model; and
updating the face identification model to increase a degree of similarity between respective embeddings for a first image frame crop from the first face track and a second image frame crop from the second face track.

3. The system of claim 2, wherein the matching comprises:
estimating a probability density function for embeddings corresponding to image frame crops of the first face track;
determining a probability density threshold based on values of the probability density function for embeddings corresponding to image frame crops of the first face track;
determining a mean embedding for image frame crops of the second face track; and
matching the first face track to the second face track based at least in part on a comparison between the probability density threshold and a value of the probability density function for the determined mean embedding.

4. The system of claim 1, wherein the grouping comprises:
initialising a respective cluster for each face track of the plurality of face tracks; and
iteratively:
determining a respective matching threshold for each cluster based on evaluations of the loss function for pairs of image frame crops within that cluster; and
merging pairs of clusters based at least in part on evaluations of the loss function between clusters and the respective matching thresholds for the clusters.

5. The system of claim 1, wherein the fine-tuning comprises:
preparing a first model branch comprising a first copy of the pre-trained face identification model and a first multilayer perceptron head;
preparing a second model branch comprising a second copy of the pre-trained face identification model and a second multilayer perceptron head;
for a plurality of iterations:
passing a first image frame crop from a given face track through the first model branch to generate a first embedding;
passing a second image frame crop from a given face track through the second model branch to generate a second embedding; and
updating parameter values of the first model branch so as to increase a degree of similarity between the first embedding and the second embedding, as measured by the loss function; and
for a subset of the plurality of iterations, updating parameter values of the second model branch based on a moving average of parameter values of the first model branch over a set of preceding iterations.

6. The system of claim 5, wherein the loss function evaluates a cross-entropy between the first embedding and the second embedding.

7. The system of claim 1, wherein:
the face identification comprises a vision transformer;
the embeddings each comprise a respective class embedding and a respective patch embedding; and
for a given pair of embeddings, the loss function measures a degree of similarity between the respective class embeddings and a degree of similarity between the respective patch embeddings.

8. The system of claim 1, wherein:
the one or more sequences of image frames is a plurality of image frames each corresponding to a respective scene depicted within a video sequence;
the operations further comprise detecting cuts in the video sequence to generate the plurality of sequences of image frames.

9. The system of claim 1, wherein:
the operations further comprise sampling a subset of the image frame crops of a given face track, wherein a temporal spacing between image frame crops in the sampled subset is greater than a temporal spacing between image frames in the respective sequence of image frame crops;
wherein the fine-tuning selectively uses the image face crops of the sampled subset.

10. The system of claim 1, wherein the operations further comprise:
determining respective crop quality scores for image frame crops of a given face track, wherein the crop quality score for a given image crop evaluates a consistency of embeddings generated by perturbed versions of the face identification model; and
determining, from the respective crop quality scores, a track quality score for the given face track; and
omitting the given face track from being used in the fine-tuning based at least in part on the track quality score.

11. A computer-implemented method comprising:
determining, using a motion tracker, a plurality of face tracks from one or more sequences of image frames, each face track corresponding to a respective instance of a respective face and comprising a respective sequence of image frame crops;
fine-tuning, using the determined plurality of face tracks, a pre-trained face identification model to generate, for image frame crops of a common face track, corresponding embeddings that have a mutually high degree of similarity as measured by a loss function;
grouping the plurality of face tracks into common identity clusters based at least in part on similarities, as measured by the loss function, between respective embeddings generated using the fine-tuned face identification model for image frame crops within different face tracks.

12. The computer-implemented method of claim 11, wherein the fine-tuning comprises:
matching a first face track to a second face track based at least in part on a similarity of corresponding embeddings generated by the face identification model; and
updating the face identification model to increase a degree of similarity between respective embeddings for a first image frame crop from the first face track and a second image frame crop from the second face track.

13. The computer-implemented method of claim 12, wherein the matching comprises:
estimating a probability density function for embeddings corresponding to image frame crops of the first face track;
determining a probability density threshold based on values of the probability density function for embeddings corresponding to image frame crops of the first face track;
determining a mean embedding for image frame crops of the second face track; and
matching the first face track to the second face track based at least in part on a comparison between the probability density threshold and a value of the probability density function for the determined mean embedding.

14. The computer-implemented method of claim 11, wherein the grouping comprises:
initialising a respective cluster for each face track of the plurality of face tracks; and
iteratively:
determining a respective matching threshold for each cluster based on evaluations of the loss function for pairs of image frame crops within that cluster; and
merging pairs of clusters based at least in part on evaluations of the loss function between clusters and the respective matching thresholds for the clusters.

15. The computer-implemented method of claim 11, wherein the fine-tuning comprises:
preparing a first model branch comprising a first copy of the pre-trained face identification model and a first multilayer perceptron head;
preparing a second model branch comprising a second copy of the pre-trained face identification model and a second multilayer perceptron head;
for a plurality of iterations:
passing a first image frame crop from a given face track through the first model branch to generate a first embedding;
passing a second image frame crop from a given face track through the second model branch to generate a second embedding; and
updating parameter values of the first model branch so as to increase a degree of similarity between the first embedding and the second embedding, as measured by the loss function; and
for a subset of the plurality of iterations, updating parameter values of the second model branch based on a moving average of parameter values of the first model branch over a set of preceding iterations.

16. One or more non-transitory storage media storing machine-readable instructions which, when executed by a computer, cause the at computer to carry out operations comprising:
determining, using a motion tracker, a plurality of face tracks from one or more sequences of image frames, each face track corresponding to a respective instance of a respective face and comprising a respective sequence of image frame crops;
fine-tuning, using the determined plurality of face tracks, a pre-trained face identification model to generate, for image frame crops of a common face track, corresponding embeddings that have a mutually high degree of similarity as measured by a loss function;
grouping the plurality of face tracks into common identity clusters based at least in part on similarities, as measured by the loss function, between respective embeddings generated using the fine-tuned face identification model for image frame crops within different face tracks.

17. The one or more non-transitory storage media of claim 16, wherein the fine-tuning comprises:
matching a first face track to a second face track based at least in part on a similarity of corresponding embeddings generated by the face identification model; and
updating the face identification model to increase a degree of similarity between respective embeddings for a first image frame crop from the first face track and a second image frame crop from the second face track.

18. The one or more non-transitory storage media of claim 17, wherein the matching comprises:
estimating a probability density function for embeddings corresponding to image frame crops of the first face track;
determining a probability density threshold based on values of the probability density function for embeddings corresponding to image frame crops of the first face track;
determining a mean embedding for image frame crops of the second face track; and
matching the first face track to the second face track based at least in part on a comparison between the probability density threshold and a value of the probability density function for the determined mean embedding.

19. The one or more non-transitory storage media of claim 16, wherein the grouping comprises:
initialising a respective cluster for each face track of the plurality of face tracks; and
iteratively:
determining a respective matching threshold for each cluster based on evaluations of the loss function for pairs of image frame crops within that cluster; and
merging pairs of clusters based at least in part on evaluations of the loss function between clusters and the respective matching thresholds for the clusters.

20. The one or more non-transitory storage media of claim 16, wherein the fine-tuning comprises:
preparing a first model branch comprising a first copy of the pre-trained face identification model and a first multilayer perceptron head;
preparing a second model branch comprising a second copy of the pre-trained face identification model and a second multilayer perceptron head;
for a plurality of iterations:
passing a first image frame crop from a given face track through the first model branch to generate a first embedding;
passing a second image frame crop from a given face track through the second model branch to generate a second embedding; and
updating parameter values of the first model branch so as to increase a degree of similarity between the first embedding and the second embedding, as measured by the loss function; and
for a subset of the plurality of iterations, updating parameter values of the second model branch based on a moving average of parameter values of the first model branch over a set of preceding iterations.
